(19) United States
(12) Patent Application Publication
(10) Pub. No.: US 2025/0322701 A1
(43) Pub. Date: Oct. 16, 2025

(54) VEHICLE INSPECTION METHOD AND VEHICLE INSPECTION SYSTEM

(71) Applicant: Nissan Motor Co., Ltd., Kanagawa (JP)

(72) Inventors: Takafumi Kishi, Kanagawa (JP); Eisuke Sato, Kanagawa (JP); Koji Tsuzaki, Kanagawa (JP); Yoshinori Itou, Kanagawa (JP); Maya Hatano, Kanagawa (JP)

(73) Assignee: Nissan Motor Co., Ltd., Kanagawa (JP)

(21) Appl. No.: 18/863,472

(22) PCT Filed: May 13, 2022
(86) PCT No.: PCT/JP2022/020241

§ 371 Date: Jul. 3, 2025

(51) Int. Cl. G07C 5/12; G01M 17/007; G07C 5/08

(52) U.S. Cl. CPC G07C 5/12; G01M 17/0072; G07C 5/0808

(57) ABSTRACT

A vehicle inspection method for a vehicle including a controller configured to control vehicle speed in an automated manner, based on a forward looking image, the vehicle inspection method including: supporting a wheel of the vehicle by a vehicle support device; acquiring a vehicle speed signal of the vehicle supported by the vehicle support device; generating a virtual image of an environment seen in a forward direction from the vehicle in such a way that the virtual image synchronizes with the vehicle speed signal; and displaying the virtual image in such a way that a camera, the camera being mounted on the vehicle and configured to generate the forward looking image, captures the virtual image.

### TECHNICAL FIELD

The present invention relates to a vehicle inspection method and a vehicle inspection system.

### BACKGROUND ART

Driving assistance devices that control at least one of a steering angle and vehicle speed of a vehicle in an automated manner and assist driving of the vehicle have been known. For example, in PTL 1 described below, a driving assistance device for vehicle that detects an obstacle, based on a captured image captured by a camera and causes a brake to operate in an automated manner is described.

### CITATION LIST

### Patent Literature

PTL1: JP 2005-196276 A

### SUMMARY OF INVENTION

### Technical Problem

Although, conventionally, when repair of a driving assistance device as described above is finished, the driving assistance device not having a malfunction and the system being normal have been confirmed, whether or not the repaired driving assistance device can exhibit original performance has not been confirmed.

An object of the present invention is to, when repair of a driving assistance device configured to control at least vehicle speed of a vehicle in an automated manner and assist driving of the vehicle is finished, confirm whether or not the repaired driving assistance device can exhibit original performance.

### Solution to Problem

According to an aspect of the present invention, there is provided a vehicle inspection method for a vehicle including a controller configured to control vehicle speed in an automated manner, based on a forward looking image, the vehicle inspection method including: supporting a wheel of the vehicle by a vehicle support device; acquiring a vehicle speed signal of the vehicle supported by the vehicle support device; generating a virtual image of an environment seen in a forward direction from the vehicle in such a way that the virtual image synchronizes with the vehicle speed signal; and displaying the virtual image in such a way that a camera, the camera being mounted on the vehicle and configured to generate the forward looking image, captures the virtual image.

### Advantageous Effects of Invention

According to an aspect of the present invention, it is possible to, when repair of a driving assistance device configured to control at least vehicle speed of a vehicle in an automated manner and assist driving of the vehicle is finished, confirm whether or not the repaired driving assistance device can exhibit original performance.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a schematic configuration diagram of an example of a vehicle inspection system of an embodiment;

FIG. 2 is a schematic diagram of a configuration of an image display device that is attached to a camera; and

FIG. 3 is a flowchart of an example of a vehicle inspection method of the embodiment.

### DESCRIPTION OF EMBODIMENTS

### Configuration

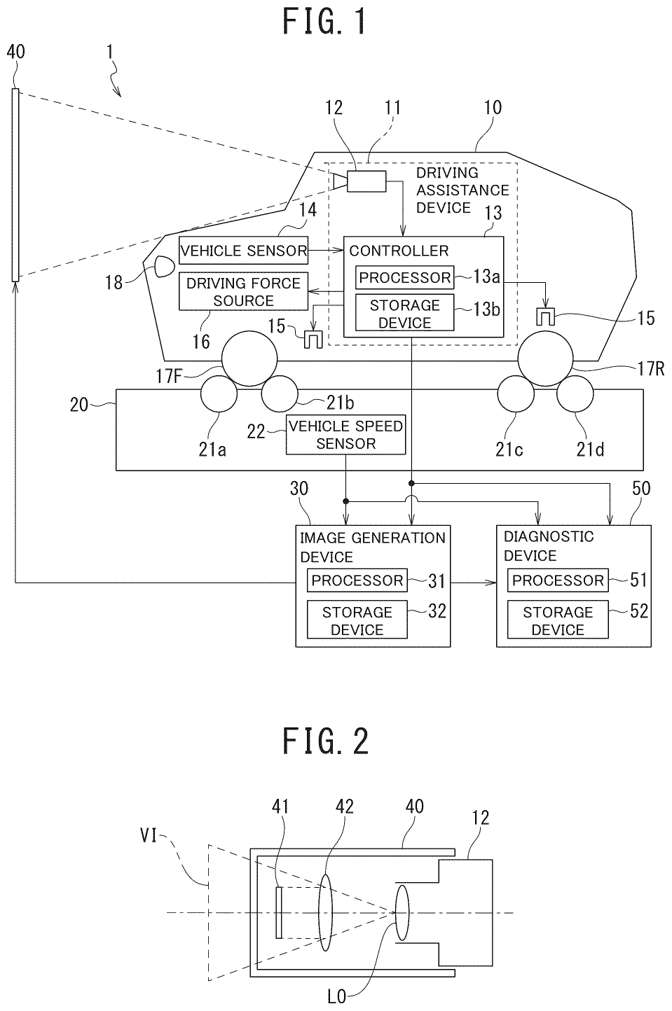

FIG. 1 is a schematic configuration diagram of an example of a vehicle inspection system of an embodiment. A vehicle inspection system 1 is a system that inspects a driving assistance device 11 of a vehicle 10 to be inspected.

The driving assistance device 11 includes a camera 12 and a controller 13. The controller 13 is an electronic control unit that performs driving assistance of the vehicle 10 to be inspected. The controller 13 performs driving assistance control to control at least vehicle speed of the vehicle 10 to be inspected in an automated manner, based on a forward looking image generated by the camera 12 capturing an image of a forward environment of the vehicle 10 to be inspected and various vehicle information acquired from the vehicle 10 to be inspected by vehicle sensors 14.

The controller 13 includes a processor 13a and an electronic circuit including peripheral components, such as a storage device 13b. The processor 13a may be, for example, a CPU or an MPU.

The storage device 13b may include a semiconductor storage device, a magnetic storage device, an optical storage device, or the like. The storage device 13b may include registers, a cache memory, and a memory, such as a ROM and a RAM, that is used as a main storage device.

Functions of the controller 13, which will be described below, are achieved by, for example, the processor 13a executing computer programs stored in the storage device 13b.

The vehicle sensors 14 include, for example, a vehicle speed sensor configured to detect vehicle speed of the vehicle 10 to be inspected, wheel speed sensors configured to detect rotational speeds of wheels of the vehicle 10 to be inspected, a triaxial acceleration sensor configured to detect acceleration and deceleration in three axial directions of the vehicle 10 to be inspected, a steering angle sensor configured to detect a steering angle of a steering wheel, a turning angle sensor configured to detect a turning angle of steered wheels, a yaw rate sensor configured to detect a yaw rate of the vehicle 10 to be inspected, an accelerator sensor configured to detect accelerator opening of the vehicle 10 to be inspected, and a brake sensor configured to detect a brake operation amount by a passenger.

The driving assistance control performed by the controller 13 may include, for example, automatic brake control to cause a braking device 15 to operate in response to an obstacle in front of the vehicle 10 to be inspected and cause the vehicle 10 to be inspected to decelerate or come to a stop in an automated manner.

In addition, for example, the driving assistance control performed by the controller 13 may include constant speed travel control to control a driving force source 16 generating a driving force of the vehicle 10 to be inspected and the braking device 15 to cause the vehicle 10 to be inspected to travel at a constant speed.

In addition, for example, the driving assistance control performed by the controller 13 may include inter-vehicle distance control to control the driving force source 16 and the braking device 15 to maintain inter-vehicle distance between the vehicle 10 to be inspected and a preceding vehicle at a target inter-vehicle distance matching the vehicle speed.

Further, the driving assistance control performed by the controller 13 may include driving assistance control to control a steering angle of the vehicle 10 to be inspected in an automated manner and thereby assist driving of the vehicle. For example, the driving assistance control may include lane departure prevention control to control the steering angle of the vehicle 10 to be inspected in such a way that the vehicle 10 to be inspected does not depart from a travel lane.

Driving assistance functions of the driving assistance device 11 for performing the automatic brake control, the constant speed travel control, the inter-vehicle distance control, and the lane departure prevention control are sometimes referred to as “automatic braking function”, “constant speed traveling function”, “inter-vehicle distance control function”, and “lane departure prevention function”, respectively, in the following description.

The vehicle inspection system 1 includes at least a vehicle support device 20, an image generation device 30, and an image display device 40.

The vehicle support device 20 may be, for example, a chassis dynamo or a free roller. The vehicle support device 20 includes rollers 21a and 21b configured to support front wheels 17F of the vehicle 10 to be inspected and rollers 21c and 21d configured to support rear wheels 17R. The rollers 21a to 21d are rotatably supported by bearings in a base of the vehicle support device 20. Directions of rotational axes of the rollers 21a to 21d are parallel with a vehicle width direction of the vehicle 10 to be inspected while the vehicle 10 to be inspected is placed on the vehicle support device 20.

The vehicle support device 20 include a vehicle speed sensor 22 configured to detect vehicle speed of the vehicle 10 to be inspected. The vehicle speed sensor 22 detects the vehicle speed of the vehicle 10 to be inspected, based on rotational speeds of rollers supporting driving wheels of the vehicle 10 to be inspected among the rollers 21a to 21d. The vehicle speed sensor 22 generates vehicle speed information representing the vehicle speed of the vehicle 10 to be inspected and outputs the generated vehicle speed information to the image generation device 30.

Note that since the wheels 17F and 17R are supported by the rotatable rollers 21a to 21d, an actual longitudinal position of a vehicle body of the vehicle 10 to be inspected does not change even when the driving wheels of the vehicle 10 to be inspected rotate. Therefore, the vehicle speed information that the vehicle speed sensor 22 outputs does not indicate actual vehicle speed of the vehicle 10 to be inspected and is information imitating vehicle speed calculated based on the wheel speed of the vehicle 10 to be inspected.

An expression “vehicle speed information of the vehicle 10 to be inspected” as used herein is used in the meaning of, instead of information about actual vehicle speed of the vehicle 10 to be inspected, information imitating vehicle speed calculated based on the wheel speed of the vehicle 10 to be inspected, information about vehicle speed calculated based on the wheel speed of the vehicle 10 to be inspected, or information equivalent to the foregoing information.

Note that the vehicle speed information of the vehicle 10 to be inspected may be acquired from the controller 13 of the driving assistance device 11. For example, the controller 13 may output information about vehicle speed detected by the vehicle speed sensor in the vehicle sensors 14 to the image generation device 30 as the vehicle speed information of the vehicle 10 to be inspected. In addition, for example, the controller 13 may output, to the image generation device 30, information about target vehicle speed set as a target of the vehicle speed of the vehicle 10 to be inspected in the automatic brake control, the constant speed travel control, and the inter-vehicle distance control. When the vehicle speed information of the vehicle 10 to be inspected is acquired from the controller 13, the vehicle speed sensor 22 can be omitted.

The image generation device 30 is an electronic control unit that generates a virtual image (that is, a simulation image) of an environment that can be seen in the forward direction of the vehicle 10 to be inspected. In the following description, a virtual image that the image generation device 30 generates is simply referred to as “virtual image”.

The image generation device 30 includes a processor 31 and an electronic circuit including peripheral components, such as a storage device 32. The processor 31 may be, for example, a CPU or an MPU.

The storage device 32 may include a semiconductor storage device, a magnetic storage device, an optical storage device, or the like. The storage device 32 may include registers, a cache memory, and a memory, such as a ROM and a RAM, that is used as a main storage device.

Functions of the image generation device 30, which will be described below, are achieved by, for example, the processor 31 executing computer programs stored in the storage device 32.

The image generation device 30 generates a virtual image, based on the vehicle speed information of the vehicle 10 to be inspected acquired from the vehicle speed sensor 22 or the controller 13 in such a way that a viewpoint of the virtual image changes in synchronization with the vehicle speed of the vehicle 10 to be inspected. That is, when the vehicle speed of the vehicle 10 to be inspected indicated by the vehicle speed information is greater than 0, the image generation device 30 generates a virtual image in such a way that a movement amount of the vehicle 10 to be inspected matching the vehicle speed and a movement amount of the viewpoint of the virtual image coincide with each other.

For example, the image generation device 30 may generate a computer graphics (CG) image as the virtual image. In the following description, a virtual image that is generated as a CG image is sometimes referred to as “CG virtual image”.

When a CG virtual image is generated, the image generation device 30 arranges objects (for example, obstacles, such as another vehicle and a person, a traffic light, a traffic sign, displays on a road surface, such as a lane boundary line, a stop line, and a road mark), or a building in a virtual space and also calculates a position of the vehicle 10 to be inspected in the virtual space, based on the vehicle speed information of the vehicle 10 to be inspected. In the following description, an object that is virtually arranged in the CG virtual image is referred to as “virtual object”, and positions of a virtual object and the vehicle 10 to be inspected in the virtual space are referred to as “virtual positions”. When a moving object is arranged as a virtual object, the image generation device 30 calculates a virtual position of the virtual object that changes as the time elapses.

The image generation device 30 calculates a relative positional relationship between the virtual position of the vehicle 10 to be inspected and the virtual position of a virtual object and generates a CG virtual image of an environment that can be seen in the forward direction from the vehicle 10 to be inspected, based on the calculated relative positional relationship.

For example, the image generation device 30 may generate a CG virtual image in accordance with a predefined test method. For example, the image generation device 30 may generate a CG virtual image in which a moving obstacle (for example, another vehicle or a person) appears in front of the vehicle 10 to be inspected in accordance with a scenario that is determined by the predefined test method. The predefined test method may be, for example, a test method determined by a new car assessment programme (NCAP) or the like. The predefined test method may be a method that causes an obstacle to appear when the vehicle 10 to be inspected is traveling within a vehicle speed range defined with respect to a test speed of the scenario and accelerator opening is detected to be constant.

In addition, for example, the image generation device 30 may generate a virtual image in which a viewpoint changes in synchronization with the vehicle speed of the vehicle 10 to be inspected, based on a real image that is acquired by capturing an image of an actual environment.

In this case, for example, the image generation device 30 reads in a real image and position information in which a capturing point at which the real image was captured and movement speed of an image capturing device are recorded. For example, the image generation device 30 may read in recorded information of a drive recorder.

The recorded information of the drive recorder includes information in which forward looking images that are captured by a camera mounted on a traveling vehicle (for example, the vehicle 10 to be inspected or another vehicle), vehicle speeds of the vehicle at respective time points at which the forward looking images were captured, and positions of the vehicle measured by a positioning device, such as a GPS, are recorded.

The image generation device 30 may generate a virtual image in which the position of the viewpoint changes in synchronization with the vehicle speed of the vehicle 10 to be inspected by controlling reproduction speed of a real image, based on the vehicle speed information of the vehicle 10 to be inspected acquired from the vehicle speed sensor 22 or the controller 13 and the recorded information in the drive recorder.

The image display device 40 displays a virtual image generated by the image generation device 30. The image display device 40 may include, for example, a screen arranged in front of the vehicle 10 to be inspected and a projection device configured to project the virtual image on the screen. In addition, the image display device 40 may be a display monitor device that is arranged in front of the vehicle 10 to be inspected and displays a virtual image.

On this occasion, it is preferable to align relative positional relationships in the up-down direction and the vehicle width direction of the vehicle 10 to be inspected between the screen or the display monitor device and the vehicle support device 20 in such a way that a vanishing point of the virtual image displayed on the screen or the display monitor device is located on an optical axis of the camera 12.

In addition, it is preferable to align a relative positional relationship in the longitudinal direction between the screen or the display monitor device and the vehicle support device 20 in such a way that when a virtual image displayed on the screen or the display monitor device is captured by the camera 12, an angle of view of a partial image of the virtual image within a range that is imaged in a captured image by the camera 12 is the same as an angle of view of the camera 12 itself.

For example, when the angle of view and an aspect ratio of the virtual image are the same as the angle of view and an aspect ratio of the camera 12, it is preferable to align a relative positional relationship in the longitudinal direction in such a way that four corners of the virtual image coincide with four corners of the capturable range by the camera 12.

When alignment between the screen or the display monitor device and the vehicle support device 20 is performed, for example, a virtual image displayed on the screen or the display monitor device may be captured by the camera 12 and the alignment may be performed based on a still image or a video output from the camera 12 in such a way that the above-described conditions of relative positional relationships in the respective directions are satisfied.

In addition, it may be configured such that, regarding the camera 12, height from a road surface, an image capturing angle with respect to a travel direction, and a capturable range are stored in a database with respect to each vehicle type, and information matching the vehicle type of the vehicle 10 to be inspected is acquired from the database and height, an angle, and a position in the longitudinal direction of the screen or the display monitor device are automatically adjusted in such a way that the viewpoint of the virtual image is positioned at the same relative position as the relative position of a viewpoint when the vehicle 10 to be inspected captures an image on a road.

The image display device 40 may include an image display device that is attachable to the camera 12. FIG. 2 is a schematic diagram of a configuration of an image display device that is attached to the camera 12.

The image display device 40 in FIG. 2 includes a display element 41 configured to display a virtual image and an optical system 42 configured to form an optical virtual image VI of an image displayed by the display element 41 in front of an objective lens LO of the camera 12 and is attachably/detachably attached to the camera 12 by a not-illustrated fixture.

Attaching the image display device 40 itself to the camera 12 enables the camera 12 to be prevented from being unable to capture a virtual image or a forward looking image generated by capturing a virtual image using the camera 12 to be prevented from degrading due to reflection of light from headlights 18 of the vehicle 10 to be inspected on an image display surface of the image display device 40 even when inspection is performed while the headlights 18 are turned on.

Note that when a virtual image is displayed on the image display device 40 that is attachable to the camera 12, the same virtual image may be displayed on both the image display device 40 that is attachable to the camera 12 and the display monitor device for an operator (an inspector or a checker) who inspects the vehicle 10 to be inspected in such a way that the operator can visually observe the same virtual image in real time.

### Vehicle Inspection Method

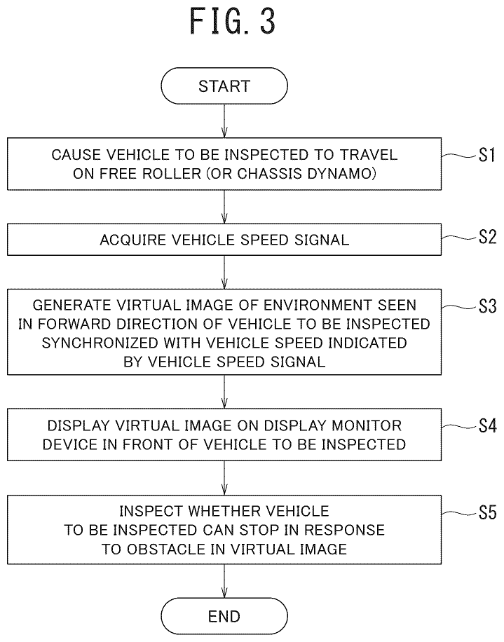

A vehicle inspection method using the above-described vehicle inspection system 1 will be described. FIG. 3 is a flowchart of an example of the vehicle inspection method when the automatic braking function is inspected.

In step S1, the vehicle 10 to be inspected is placed on the vehicle support device 20 that is a chassis dynamo or a free roller, and the vehicle 10 to be inspected is caused to travel while the wheels 17F and 17R are supported by the rollers 21a to 21d. On this occasion, since the wheels 17F and 17R are supported by the rotatable rollers 21a to 21d, the driving wheels of the vehicle 10 to be inspected only rotate and an actual longitudinal position of the vehicle 10 to be inspected does not change. An expression “the vehicle 10 to be inspected is caused to travel” as used herein is used in the meaning of driving the driving wheels of the vehicle 10 to be inspected on the vehicle support device 20.

In step S2, the image generation device 30 acquires vehicle speed information of the vehicle 10 to be inspected from the vehicle speed sensor 22 or the controller 13.

In step S3, the image generation device 30 generates a virtual image of an environment that can be seen in the forward direction from the vehicle 10 to be inspected. When the automatic braking function is inspected, the image generation device 30 may generate, for example, a captured image in which an obstacle (for example, another vehicle or a person) runs out in front of the vehicle 10 to be inspected. The image generation device 30 changes a viewpoint of the virtual image in synchronization with the vehicle speed of the vehicle 10 to be inspected, based on the vehicle speed information of the vehicle 10 to be inspected. That is, when the vehicle speed of the vehicle 10 to be inspected is greater than 0, the image generation device 30 generates a virtual image in which an obstacle comes close to the viewpoint of the virtual image as time passes.

In step S4, the image display device 40 (for example, the display monitor device arranged in front of the vehicle 10 to be inspected) displays the virtual image generated by the image generation device 30.

In step S5, the camera 12 captures the virtual image displayed by the image display device 40 and generates a forward looking image. The controller 13 recognizes an image of an obstacle in the forward looking image (that is, an image of an obstacle in the virtual image) by performing image recognition processing on the forward looking image. For example, the controller 13 can recognize an image of an obstacle by an existing method, such as pattern matching.

The controller 13 performs the automatic brake control in response to the recognized obstacle. That is, the controller 13 causes the braking device 15 of the vehicle 10 to be inspected to operate and reduces the vehicle speed of the vehicle 10 to be inspected that is traveling on the vehicle support device 20 by a braking force and causes the vehicle 10 to be inspected to stop. An obstacle in the virtual image comes close to the viewpoint of the virtual image as time passes in synchronization with the vehicle speed of the vehicle 10 to be inspected that decreases by the braking force.

Whether or not the vehicle 10 to be inspected can stop at a position before the obstacle in the virtual image is inspected.

For example, when the image generation device 30 generates a CG virtual image, whether or not the vehicle 10 to be inspected can stop at a position before the obstacle is inspected in a virtual space. Whether or not the vehicle 10 to be inspected has been able to stop at a position before the obstacle may, for example, be determined or confirmed by the operator (the inspector or the checker) who inspects the vehicle 10 to be inspected. The operator may inspect whether or not the vehicle 10 to be inspected can stop at a position before the obstacle by visually observing the CG virtual image displayed on the image display device 40.

In addition, the vehicle inspection system 1 may include a diagnostic device 50 configured to diagnose an inspection result of the driving assistance device 11.

The diagnostic device 50 is an electronic control unit that diagnoses an inspection result of the driving assistance device 11 inspected by the vehicle inspection system 1. The diagnostic device 50 includes a processor 51 and an electronic circuit including peripheral components, such as a storage device 52. The processor 51 may be, for example, a CPU or an MPU.

The storage device 52 may include a semiconductor storage device, a magnetic storage device, an optical storage device, or the like. The storage device 52 may include registers, a cache memory, and a memory, such as a ROM and a RAM, that is used as a main storage device.

Functions of the diagnostic device 50, which will be described below, are achieved by, for example, the processor 51 executing computer programs stored in the storage device 52.

The diagnostic device 50 acquires vehicle speed information of the vehicle 10 to be inspected from the vehicle speed sensor 22 or the controller 13 and also receives virtual positions of an obstacle and the vehicle 10 to be inspected in a virtual space from the image generation device 30. The diagnostic device 50 inspects whether or not the vehicle 10 to be inspected can stop at a position before the obstacle in the virtual space. For example, the diagnostic device 50 inspects whether or not the vehicle 10 to be inspected can stop (whether or not a vehicle speed signal indicates 0) before a relative positional relationship between a virtual position of the obstacle and a virtual position of the vehicle 10 to be inspected is brought into a positional relationship in which the obstacle and the vehicle 10 to be inspected come into contact with each other. When the vehicle speed signal of the vehicle 10 to be inspected indicates 0 before the relative positional relationship between the virtual position of the obstacle and the virtual position of the vehicle 10 to be inspected is brought into the positional relationship in which the obstacle and the vehicle 10 to be inspected come into contact with each other, the diagnostic device 50 determines that the vehicle 10 to be inspected has stopped without contact with the obstacle. In addition, the vehicle 10 to be inspected comes closer to an obstacle when delay occurs for a period from an appearance of the obstacle until the controller 13 recognizes the obstacle or a period from when the braking device 15 is actuated until deceleration is generated in the vehicle 10 to be inspected than when no such delay occurs. In addition, when a braking force generated by the braking device 15 is small, distance that the vehicle 10 to be inspected travels until the vehicle 10 to be inspected stops becomes long and the vehicle 10 to be inspected comes closer to the obstacle. When the relative positional relationship between the virtual position of the obstacle and the virtual position of the vehicle 10 to be inspected has been brought into the positional relationship in which the obstacle and the vehicle 10 to be inspected come into contact with each other, the diagnostic device 50 determines that the vehicle 10 to be inspected has not stopped before the obstacle. That is, the diagnostic device 50 determines that the obstacle and the vehicle 10 to be inspected in the virtual image have come into contact with each other.

When it is determined that the obstacle and the vehicle 10 to be inspected in the virtual image have come into contact with each other, the image generation device 30 generates an animation indicating the contact or an image including an alert display and the image display device 40 displays the image that the image generation device 30 generates.

In addition, for example, when real images obtained by capturing, by a drive recorder, a scene in which a vehicle comes into contact with an obstacle and a scene in which the vehicle stops immediately before coming into contact with the obstacle are available, the diagnostic device 50 may display a virtual image based on such a real image by the image display device 40 and thereby inspect whether or not the vehicle to be inspected can stop at a position before the obstacle.

In this case, the diagnostic device 50 can inspect whether or not the vehicle 10 to be inspected can stop at a position before an obstacle by confirming whether or not the vehicle speed information of the vehicle 10 to be inspected becomes 0 and the virtual image comes to a stop before a scene displayed on the image display device 40 leads to a scene in which the vehicle has come into contact with the obstacle or a scene in which the vehicle has stopped immediately before the contact.

Examples in which a driving assistance function other than the automatic braking function is inspected will be described below.

When the constant speed traveling function is inspected, the image generation device 30 generates a virtual image of an environment that can be seen in the forward direction from a vehicle traveling on a road, in step S3. The image generation device 30 may generate a CG virtual image or generate a virtual image based on a real image that the drive recorder captured during traveling.

In step S5, vehicle speed information of the vehicle 10 to be inspected is acquired and whether or not the vehicle speed information of the vehicle 10 to be inspected indicates a speed less than or equal to a speed limit indicated by a speed limit sign in the virtual image or whether or not the vehicle speed information indicates a speed less than or equal to an upper limit speed that is set for the vehicle 10 to be inspected in advance is inspected.

When the inter-vehicle distance control function is inspected, the image generation device 30 generates a CG virtual image of an environment that can be seen in the forward direction from a vehicle traveling on a road following a preceding vehicle, in step S3.

In step S5, whether or not inter-vehicle distance between the vehicle 10 to be inspected and the preceding vehicle is appropriate is inspected. For example, the diagnostic device 50 may inspect whether or not inter-vehicle distance between the vehicle 10 to be inspected and the preceding vehicle in the virtual space coincides with a target inter-vehicle distance that is set according to the vehicle speed of the vehicle 10 to be inspected.

Alternatively, the operator (the inspector or the checker) who inspects the vehicle 10 to be inspected may determine whether or not inter-vehicle distance to the preceding vehicle is appropriate by visually observing the CG virtual image.

When the lane departure prevention function is inspected, the image generation device 30 generates a virtual image of an environment that can be seen in the forward direction from a vehicle traveling on a road having a curvature larger than 0, in step S3. The image generation device 30 may generate a CG virtual image or generate a virtual image based on a real image that the drive recorder captured during traveling.

In step S5, a steering angle command signal of a steering angle of the vehicle 10 to be inspected is acquired from the controller 13. Note that lest the steered wheels of the vehicle 10 to be inspected be actually turned on the chassis dynamo or the free roller, a steering actuator of the vehicle 10 to be inspected is disabled in advance.

Based on the steering angle command signal acquired from the controller 13, whether or not the steered wheels are turned in a direction in which the vehicle 10 to be inspected is prevented from departing from a lane is inspected.

Note that when the lane departure prevention function is inspected using a CG virtual image, the image generation device 30 may generate a CG virtual image imitating steering of the vehicle 10 to be inspected.

In this case, the image generation device 30 acquires a steering angle command signal of the vehicle 10 to be inspected from the controller 13, calculates a yaw angle of the vehicle body of the vehicle 10 to be inspected in a virtual space, based on the vehicle speed information and the steering angle command signal of the vehicle 10 to be inspected, and generates a CG virtual image of an environment that can be seen in the forward direction from the vehicle, based on the calculated yaw angle.

Note that in addition to the above-described driving assistance functions, an automatic high beam function of the vehicle 10 to be inspected may be inspected. The automatic high beam function is a function to detect light from the headlights of an oncoming vehicle by an illuminance sensor attached at any position (for example, a side mirror) on the vehicle 10 to be inspected and automatically switch the headlights 18 of the vehicle 10 to be inspected between a high beam state and a low beam state.

When the automatic high beam function is inspected, for example, a virtual image in which the vehicle 10 to be inspected and an oncoming vehicle pass each other at night is displayed and whether or not the headlights 18 is switched to the low beam state when an oncoming vehicle exists and whether or not the headlights 18 is switched to the high beam state when no oncoming vehicle exists are inspected. On this occasion, by covering the headlights 18 in advance, light from the headlights 18 may be prevented from being reflected by an image display surface of the display monitor device or the screen of the image display device 40

In addition, an adaptive light function of the vehicle 10 to be inspected may be inspected. The adaptive light function is a function to detect another vehicle or a pedestrian in front of the vehicle 10 to be inspected from a forward looking image captured by the camera 12 and automatically deflect an optical axis of the headlights 18 of the vehicle 10 to be inspected from the another vehicle or the pedestrian.

When the automatic high beam function is inspected, a virtual image in which another vehicle or a pedestrian appears in front of the vehicle 10 to be inspected is displayed and whether or not a direction of the headlights 18 is automatically controlled in such a way that the optical axis of the headlights 18 of the vehicle 10 to be inspected deflects from the another vehicle or the pedestrian is inspected. On this occasion, to prevent the camera 12 from being unable to capture a virtual image or a forward looking image generated by capturing a virtual image by the camera 12 from degrading due to light from the headlights 18, a virtual image may be presented to the camera 12 by the image display device described with reference to FIG. 2 (that is, an image display device attachable to the camera 12).

### Advantageous Effects of Embodiment

(1) The vehicle inspection system 1 inspects the vehicle 10 to be inspected including the controller 13 configured to control vehicle speed in an automated manner, based on a forward looking image. The vehicle inspection system 1 includes the vehicle support device 20 configured to support wheels of the vehicle 10 to be inspected, the image generation device 30 configured to acquire a vehicle speed signal of the vehicle 10 to be inspected supported by the vehicle support device 20 and generate a virtual image of an environment seen in the forward direction from the vehicle 10 to be inspected in such a way that the virtual image synchronizes with a vehicle speed signal, and the image display device 40 configured to display a virtual image in such a way that the camera 12 mounted on the vehicle 10 to be inspected and configured to generate a forward looking image captures the virtual image.

The vehicle support device 20 may be, for example, a chassis dynamo or a free roller.

Because of this configuration, when repair of the driving assistance device 11 configured to control at least vehicle speed in an automated manner and assist driving of the vehicle 10 to be inspected is finished, whether or not the repaired driving assistance device 11 can exhibit original performance can be confirmed.

For example, at least one of the automatic braking function, the constant speed traveling function, the inter-vehicle distance control function, the lane departure prevention function, the automatic high beam function, and the adaptive light function that are achieved by the controller 13 included in the vehicle 10 to be inspected may be inspected.

(2) The vehicle inspection system 1 may acquire a vehicle speed signal from the vehicle support device 20 or the vehicle 10 to be inspected.

Because of this configuration, a virtual image with which a vehicle speed signal of the vehicle 10 to be inspected is synchronized can be generated.

(3) In inspection of the automatic braking function, an image in which when the vehicle speed is higher than 0, an obstacle in front of the vehicle 10 to be inspected comes close to the vehicle 10 to be inspected may be generated as a virtual image and whether or not the vehicle 10 to be inspected stops before the obstacle may be determined.

Because of this configuration, whether or not the automatic braking function of the vehicle 10 to be inspected exhibits original performance can be inspected.

(4) The image generation device 30 may generate a virtual image in accordance with a predefined test method.

Because of this configuration, inspection in accordance with a predefined test method can be performed.

(5) The image generation device 30 may acquire a steering command signal of a steering angle of the vehicle 10 to be inspected from the controller 13, calculate a yaw angle of the vehicle 10 to be inspected, based on the steering command signal and a vehicle speed signal, and generate a virtual image matching the calculated yaw angle.

Because of this configuration, the driving assistance device 11 that controls a steering angle in an automated manner, based on a forward looking image can be inspected.

(6) The image display device 40 may display a virtual image on a display monitor device arranged in front of the vehicle 10 to be inspected or may project a virtual image on a screen arranged in front of the vehicle 10 to be inspected.

Because of this configuration, the driving assistance device 11 that assists driving of the vehicle 10 to be inspected, based on a forward looking image generated by capturing a virtual image can be inspected.

(7) The image display device 40 including a display element and an optical system configured to form an optical virtual image of an image displayed by the display element in front of an objective lens of the camera 12 may be attached to the camera 12 and a virtual image may be displayed by the image display device 40.

Because of this configuration, the camera 12 of the vehicle 10 to be inspected can generate a forward looking image obtained by capturing a virtual image. In addition, it is possible to prevent the camera 12 from being unable to capture a virtual image and a forward looking image generated by capturing a virtual image using the camera 12 from degrading even when inspection is performed while the headlights 18 of the vehicle 10 to be inspected are turned on.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

### REFERENCE SIGNS LIST

1 Vehicle inspection system
10 Vehicle to be inspected
11 Driving assistance device
12 Camera
13 Controller
13a, 31, 51 Processor
13b, 32, 52 Storage device
14 Vehicle sensor
15 Braking device
16 Driving force source
17F Front wheel
17R Rear wheel
18 Headlight
20 Vehicle support device
21a to 21d Roller
22 Vehicle speed sensor
30 Image generation device
40 Image Display device
41 Display element
42 Optical system
50 Diagnostic device
LO Objective lens

1. A vehicle inspection method for a vehicle including a controller configured to control vehicle speed in an automated manner, based on a forward looking image, the vehicle inspection method comprising:
supporting a wheel of the vehicle by a vehicle support device;
acquiring a vehicle speed signal of the vehicle supported by the vehicle support device;
generating a virtual image of an environment seen in a forward direction from the vehicle in such a way that the virtual image synchronizes with the vehicle speed signal and an obstacle moving in front of the vehicle appears in the virtual image in accordance with a scenario that is determined by a predefined test method; and
acquiring characteristics of a camera, the camera being mounted on the vehicle and configured to generate the forward looking image, the characteristics being at least any of height from a road surface, an image capturing angle with respect to a travel direction, and a capturable range from a database storing the characteristics of the camera respect to each vehicle type, adjusting at least any of height, an angle, and a position in the longitudinal direction of an image display device, and displaying the virtual image in such a way that the camera captures the virtual image,
wherein, in inspection of an automatic braking function, the vehicle inspection method generates an image in which when the vehicle speed is higher than 0, an obstacle in front of the vehicle comes close to the vehicle as the virtual image and determines whether or not the vehicle stops before an obstacle.

2. The vehicle inspection method according to claim 1, wherein the vehicle support device is a chassis dynamo or a free roller.

3. The vehicle inspection method according to claim 1, wherein the vehicle inspection method acquires the vehicle speed signal from the vehicle support device or the vehicle.

4. The vehicle inspection method according to claim 1, wherein the vehicle inspection method inspects at least one of an automatic braking function, a constant speed traveling function, an inter-vehicle distance control function, a lane departure prevention function, an automatic high beam function, and an adaptive light function achieved by the controller included in the vehicle.

5. (canceled)

6. (canceled)

7. The vehicle inspection method according to claim 1 comprising:
acquiring a steering angle command signal of a steering angle of the vehicle from the controller; and
calculating a yaw angle of the vehicle, based on the steering angle command signal and the vehicle speed signal and generating the virtual image matching the calculated yaw angle.

8. The vehicle inspection method according to claim 1, wherein the vehicle inspection method displays the virtual image on a display monitor device arranged in front of the vehicle or projects the virtual image on a screen arranged in front of the vehicle.

9. The vehicle inspection method according to claim 1 comprising:
attaching a display device including a display element and an optical system configured to form an optical virtual image of an image displayed by the display element in front of an objective lens of the camera to the camera; and
displaying the virtual image by the display device.

10. A vehicle inspection system for a vehicle including a controller configured to control vehicle speed in an automated manner, based on a forward looking image, the vehicle inspection system comprising:
a vehicle support device configured to support a wheel of the vehicle;
an image generation device configured to acquire a vehicle speed signal of the vehicle supported by the vehicle support device and, in inspection of an automatic braking function, generate a virtual image of an environment seen in a forward direction from the vehicle in such a way that:
the virtual image synchronizes with the vehicle speed signal;
an obstacle moving in front of the vehicle appears in the virtual image in accordance with a scenario that is determined by a predefined test method; and,
when the vehicle speed is higher than 0, an obstacle in front of the vehicle comes close to the vehicle;
an image display device displaying the virtual image, the image display device being configured to: acquire characteristics of a camera, the camera being mounted on the vehicle and configured to generate the forward looking image, the characteristics being at least any of height from a road surface, an image capturing angle with respect to a travel direction, and a capturable range from a database storing the characteristics of the camera respect to each vehicle type; adjust at least any of height, an angle, and a position in the longitudinal direction of the image display device; and displays the virtual image in such a way that the camera captures the virtual image; and
a diagnostic device configured to determine whether or not the vehicle stops before an obstacle.

11. The vehicle inspection method according to claim 1, wherein the vehicle inspection method generates the virtual image in accordance with a predefined test method, such that an obstacle appears in front of the vehicle when the vehicle speed is within a vehicle speed range defined by the test method and accelerator opening is detected to be constant.
